(19) United States
(12) Patent Application Publication
(10) Pub. No.: US 2013/0073329 A1
(43) Pub. Date: Mar. 21, 2013

(54) Method and System for Calendaring Events

(71) Applicants: Yoav Shoham, Los Altos Hills, CA (US); Zachary Cain, (US); Caroline Suen, San Jose, CA (US)

(72) Inventors: Yoav Shoham, Los Altos Hills, CA (US); Zachary Cain, (US); Caroline Suen, San Jose, CA (US)

(73) Assignee: The Board of Trustees of the Leland Stanford Junior University, Palo Alto, CA (US)

(21) Appl. No.: 13/593,459

(22) Filed: Aug. 23, 2012

Related U.S. Application Data
(60) Provisional application No. 61/527,074, filed on Aug. 24, 2011.

(51) Int. Cl. G06Q 10/10

(52) U.S. Cl. 705/7.18

(57) ABSTRACT

Described herein are methods for implementing a calendaring system for managing flexible events. In an embodiment of the present invention, a method is disclosed where an individual's currently calendared events are considered when scheduling a new flexible event. For example, given an individual's many previously scheduled events, a method of the present invention considers the flexibility of the new event to be scheduled to find its appropriate time slots. From the appropriate time slots, the flexible event is then scheduled. In this way, the flexible event need not be scheduled at only one time but can be scheduled as its specified attributes allow. Moreover, as further events are entered the new or pre-existing events with flexible attributes can be re-scheduled toward resolving conflicts.

### CROSS-REFERENCE TO RELATED APPLICATIONS

This application claims priority to U.S. Provisional Application No. 61/527074 filed Aug. 24, 2011, which is hereby incorporated by reference in its entirety for all purposes.

### FIELD OF THE INVENTION

The present invention generally relates to the field of personal information management. More particularly, the present invention relates to methods for the calendaring of events.

### BACKGROUND OF THE INVENTION

Individuals in today's technological world are inundated with much information including information about many events that may be occurring throughout the day, throughout a week, and throughout a year, where potentially many of these events may present time conflicts. Personal information management tools such as calendaring systems can be helpful in managing an individual's events. Calendaring systems are provided by companies such as Google, Microsoft, and Apple.

Typical of these calendaring systems is that individual events are entered with specific dates and times. In this way, the calendaring tool can help an individual manage his events. Basically, these tools provide for entering fixed information about a particular event. Because of this, these tools do not provide much flexibility when events may be in conflict with each other or when events may be flexible or optional. For example, where events may be in conflict with each other, an individual is required to manually evaluate the events and make individual decisions for each event so as to resolve the conflict. This can be cumbersome and time-consuming and provides a high likelihood of scheduling conflicting events.

Typical calendaring systems also provide for listing long-term tasks such as To-do lists but do not provide a manner by which to integrate the long-term tasks into individually scheduled events in an individual's calendar.

### SUMMARY OF THE INVENTION

Therefore, there is a need in the art for a calendaring tool that can automatically manage conflicts. There is further a need for a calendaring tool that can manage flexible or optional events and reschedule them as necessary. Moreover, there is a need for a calendaring tool that takes listings of long-term tasks and provides individually scheduled events to a user toward completing the long-term tasks.

Among other things, the present invention provides for calendaring flexible events. Flexible events can include, for example, flexible time events, events tagged with different priorities or characteristics, conditional events, multiple choice events, long-term tasks. Flexible time events are, in one embodiment, events that can be completed during predetermined times in one or more days but that do not need to be completed at any specific time. Tags for events with tagged priorities or characteristics can include, for example, priority tags that provides for automatic conflict resolution. Also, tags can include, for example, characteristics for events that may be able to be simultaneously scheduled. Conditional events are, in an embodiment, alternative events that are conditioned on certain criteria (e.g., schedule run if sunny, otherwise schedule gym workout). Multiple choice events are events that can be alternatively chosen at a later date. Long-term tasks are, for example, events that can or need to occur over several days, weeks, or months. For example, learning a foreign language is a long-term task that must be done over several weeks or months.

Described herein are methods for implementing a calendaring system for managing flexible events. For an embodiment of the present invention, a method is disclosed where an individual's currently calendared events are considered when scheduling a new flexible event. For example, given an individual's many previously scheduled events, a method of the present invention considers the flexibility of the new event to be scheduled to find its appropriate time slots. From the appropriate time slots, the flexible event is then scheduled. In this way, the flexible event need not be scheduled at only one time but can be scheduled as its specified flexible attributes allow. Moreover, as further events are entered the new or pre-existing events with flexible attributes can be re-scheduled toward resolving conflicts.

For clarity and so as to illustrate the breadth of the present invention, various particular embodiments are disclosed, none of which is intended to be limiting. For example, details are provided for handling different types of flexible events and their associated parameters. Moreover, details are provided of a particular embodiment that uses an API to interface with Google's calendaring system.

These and other embodiments can be more fully appreciated upon an understanding of the detailed description of the invention as disclosed below in conjunction with the attached figures.

### BRIEF DESCRIPTION OF THE DRAWINGS

The following drawings will be used to more fully describe embodiments of the present invention.

FIG. 1 is a block diagram of a computer system on which the present invention can be implemented.

FIG. 2 is a block diagram of a networked computer system on which the present invention can be implemented.

FIGS. 3A-3G are flowcharts of methods according to embodiments of the present invention.

FIG. 4 is a dialog box according to an embodiment of the present invention.

FIGS. 5A-5G are examples of calendaring interfaces according to an embodiment of the present invention.

FIGS. 6A-6B are examples of using event tags according to an embodiment of the present invention.

FIGS. 7A-7B are examples of using conditional events according to an embodiment of the present invention.

FIG. 8 is an example of using flexible time events according to an embodiment of the present invention.

FIGS. 9-10 are examples of using multiple choice events according to an embodiment of the present invention.

FIGS. 11-17 are examples of using long-term events according to an embodiment of the present invention.

### DETAILED DESCRIPTION OF THE INVENTION

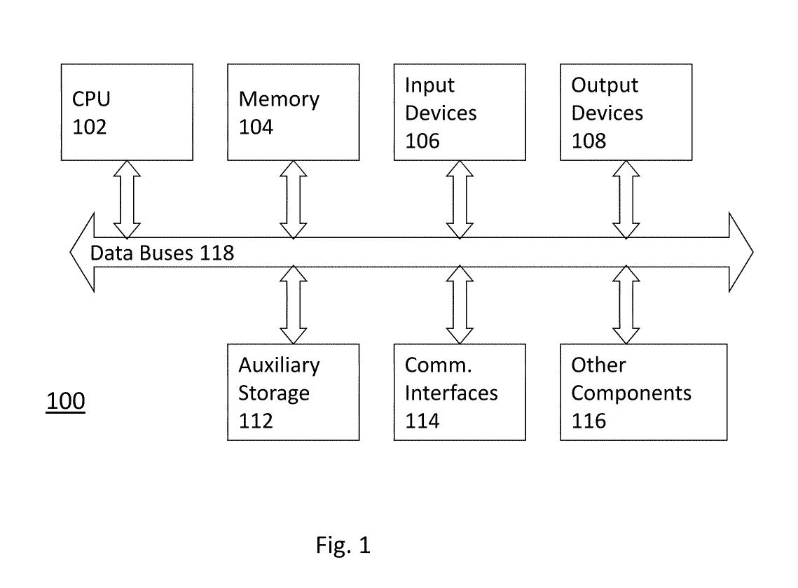

Among other things, the present invention relates to methods, techniques, and algorithms that are intended to be implemented in digital computer system 100 such as generally shown in FIG. 1. Such a digital computer or embedded device is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or “smart” televisions as they become available.

Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the art would be familiar with such details.

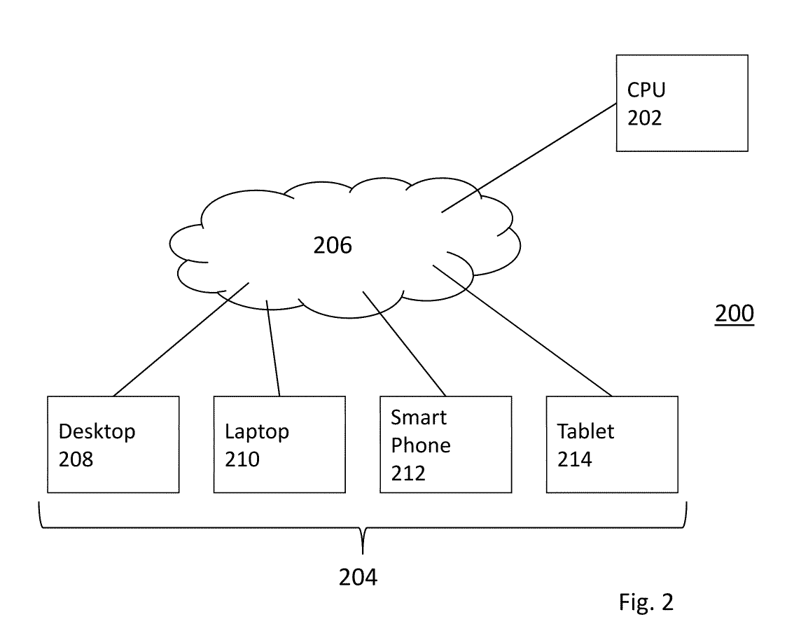

In an embodiment of the invention as shown in FIG. 2, a computer server that implements certain of the methods of the invention is remotely situated from a user. Computer server 202 is communicatively coupled so as to receive information from a user; likewise, computer server 202 is communicatively coupled so as to send information to a user. In an embodiment of the invention, the user uses user computing device 204 so as to access computer server 202 via network 206. Network 206 can be the internet, a local network, a private network, a public network, or any other appropriate network as may be appropriate to implement the invention as described herein.

User computing device 204 can be implemented in various forms such as desktop computer 208, laptop computer 210, smart phone 212, or tablet device 214. Other devices that may be developed and are capable of the computing actions described herein are also appropriate for use in conjunction with the present invention.

In the present disclosure, computing and other activities will be described as being conducted on either computer server 202 or user computing device 204. It should be understood, however, that many if not all of such activities may be reassigned from one to the other device while keeping within the present teachings. For example, for certain steps computations that may be described as being performed on computer server 202, a different embodiment may have such computations performed on user computing device 204.

In an embodiment of the invention, computer server 202 is implemented as a web server on which Apache HTTP web server software is run. Computer server 202 can also be implemented in other manners such as an Oracle web server (known as Oracle iPlanet Web Server). In an embodiment computer server 202 is a UNIX-based machine but can also be implemented in other forms such as a Windows-based machine. Configured as a web server, computer server 202 is configured to serve web pages over network 206 such as the internet.

In an embodiment, user computing device 204 is configured so as to run web browser software. For example, where user computing device 204 is implemented as desktop computer 208 or laptop computer 210, currently available web browser software includes Internet Explorer, Firefox, and Chrome. Other browser software is available for different applications of user computing device 204. Still other software is expected to be developed in the future that is able to execute certain steps of the present invention.

In an embodiment, user computing device 204, through the use of appropriate software, queries computer server 202. Responsive to such query, computer server 202 provides information so as to display certain graphics and text on user computing device. In an embodiment, the information provided by computer server 202 is in the form of HTML that can be interpreted by and properly displayed on user computing device 204. Computer server 202 may provide other information that can be interpreted on user computing device.

Among other things, the present invention provides for calendaring flexible events. To be described first is a general method for implementing a calendaring system for managing flexible events. In an embodiment of the present invention, a method is disclosed where an individual's currently calendared events are considered when scheduling a new flexible event. To follow are details for implementing various types of flexible events including flexible time events, events tagged with different priorities or characteristics, conditional events, multiple choice events, long-term tasks. Afterward, a particular embodiment will be described that has been implemented using an API to interface with Google's calendaring system.

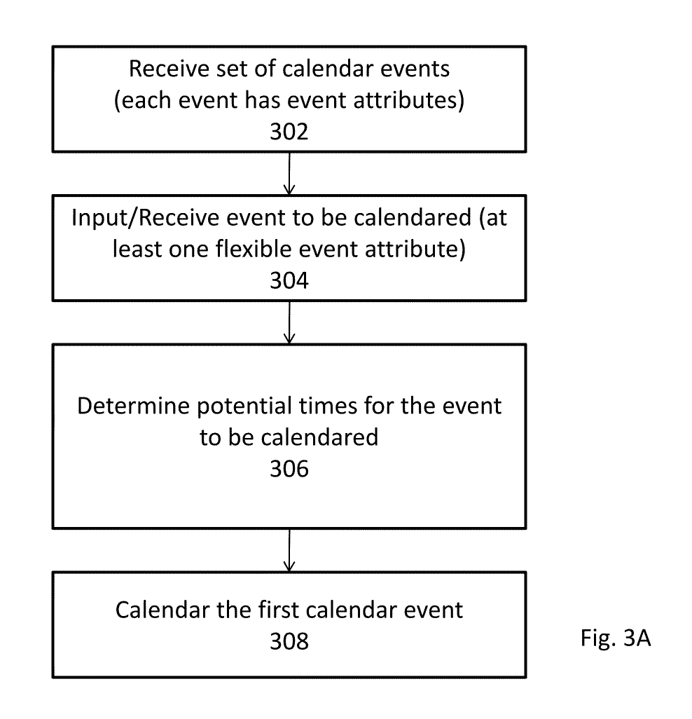

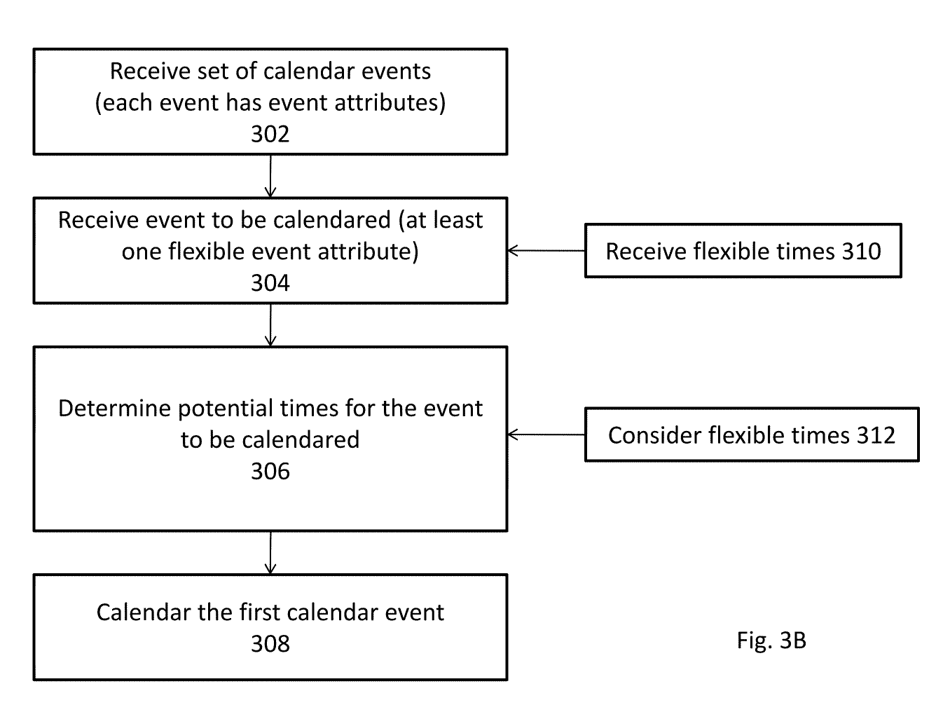

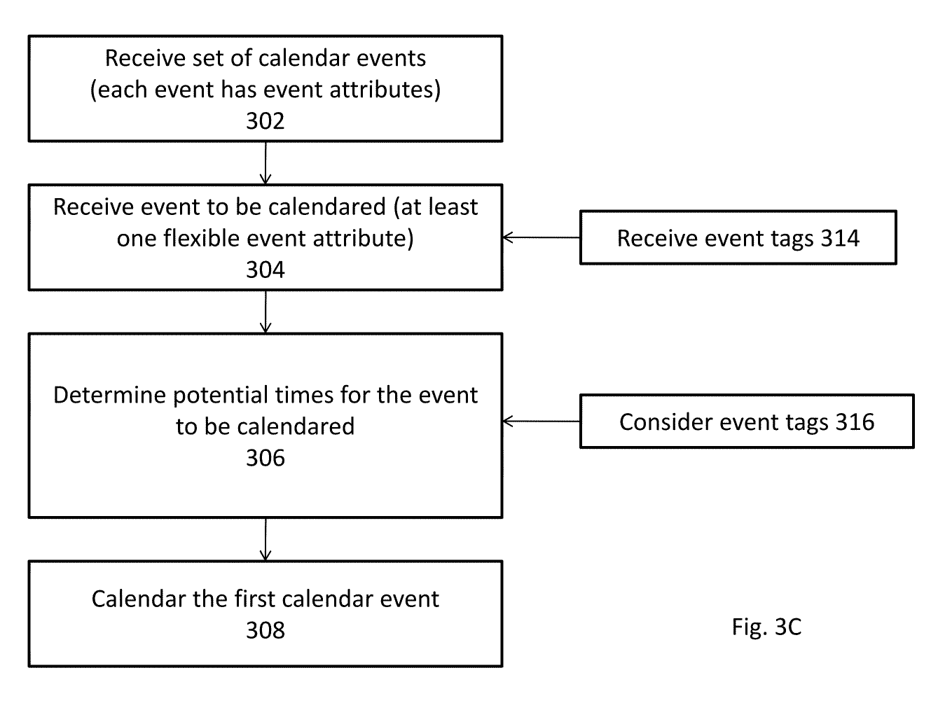

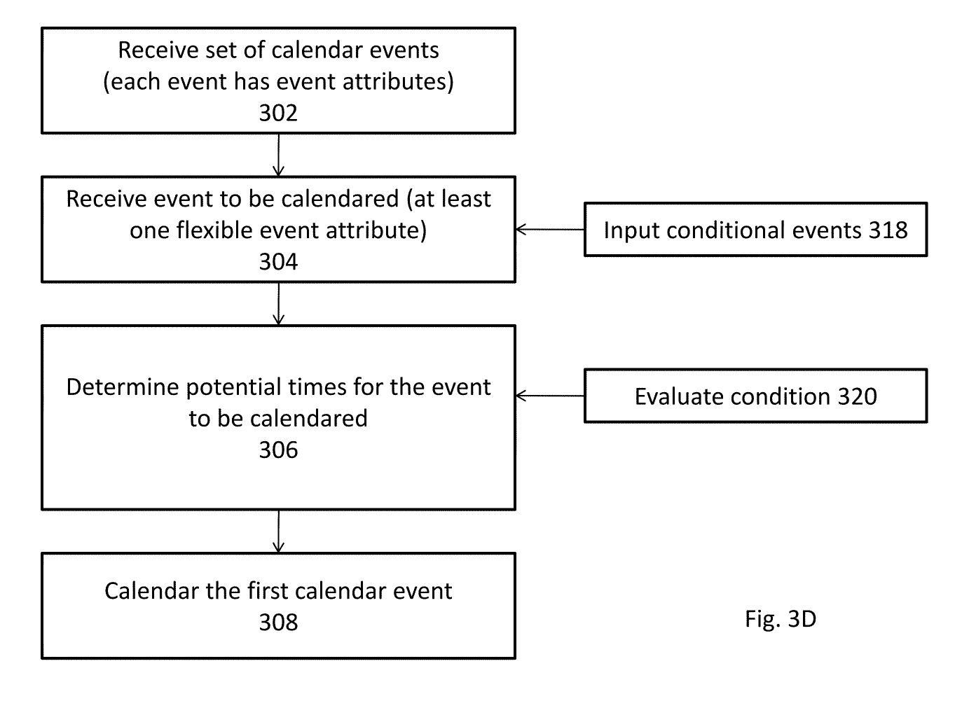

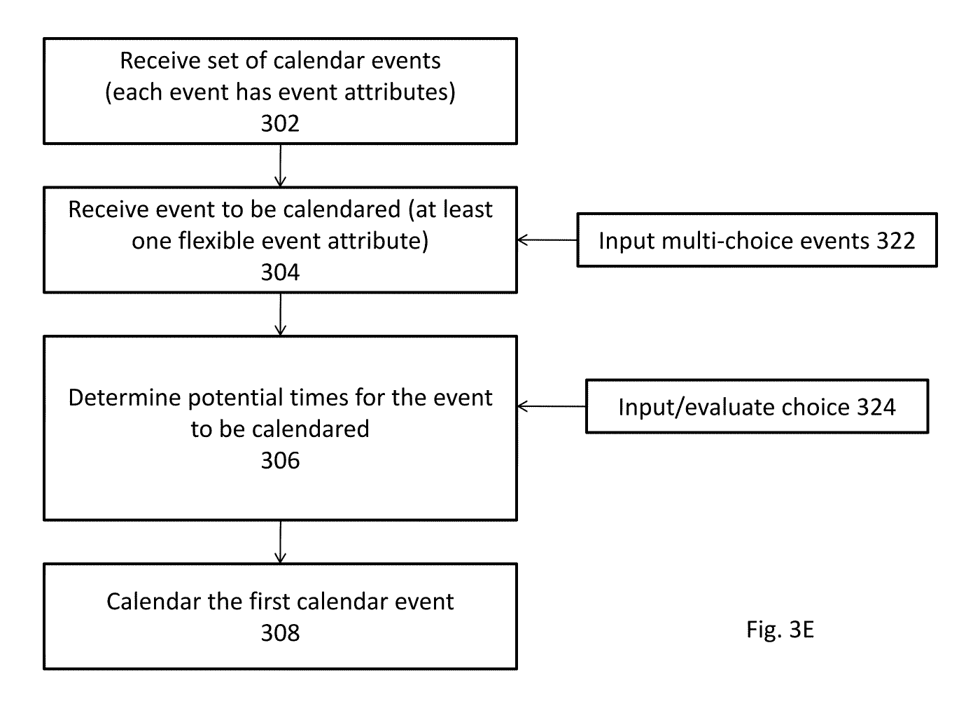

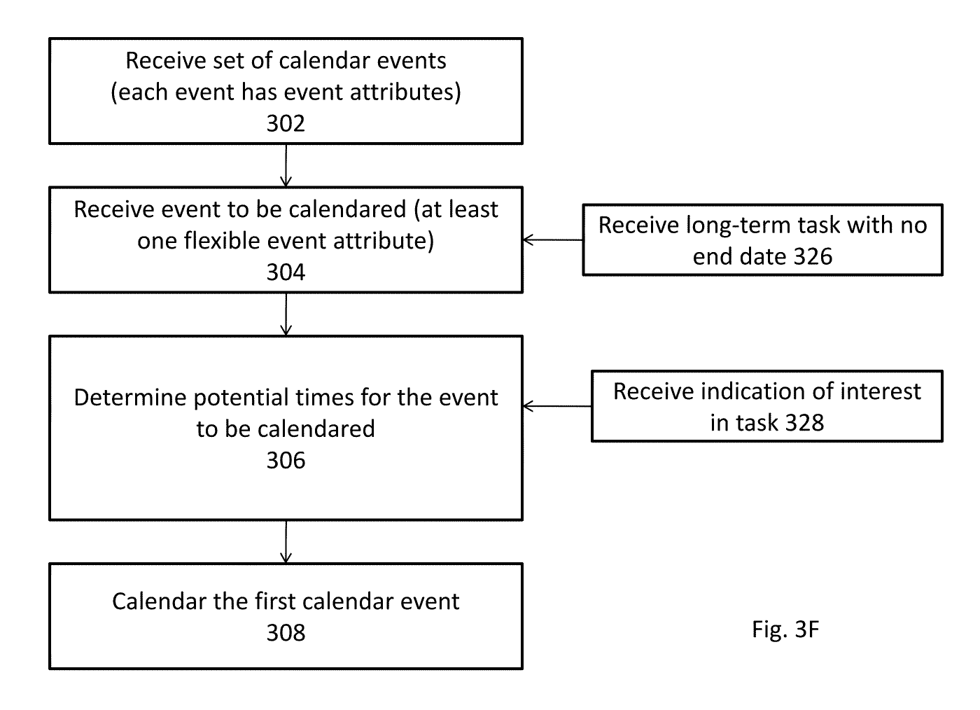

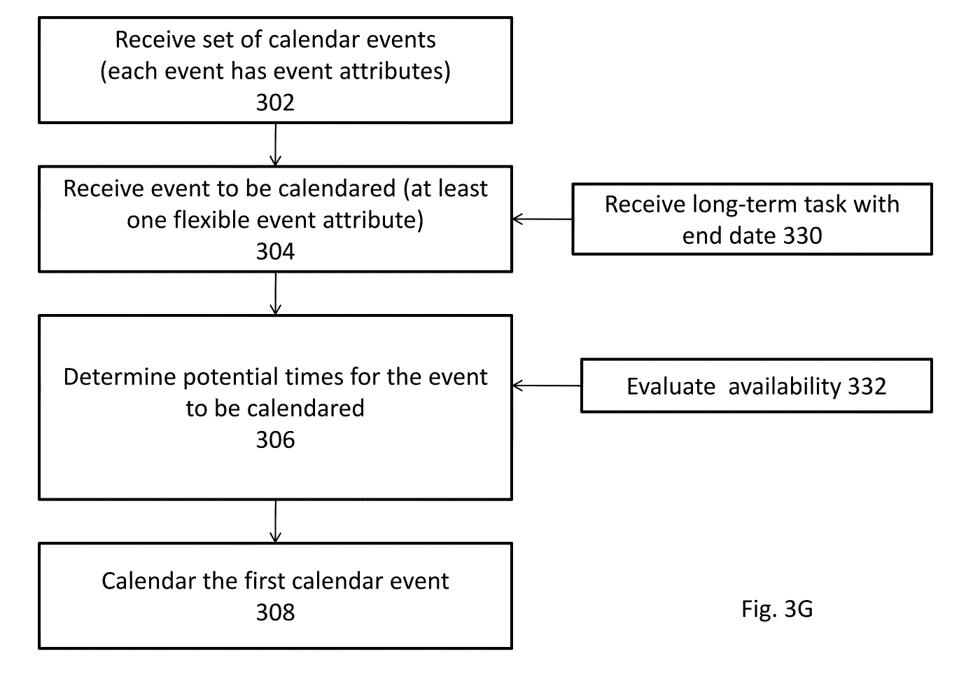

Shown in FIG. 3A is a method for calendaring flexible events according to an embodiment of the present invention. Although the method of FIG. 3A is described in conjunction with the various system representations set forth herein, persons skilled in the art will understand that any system that describes the method steps, in any order, falls within the scope of the present invention.

As shown in FIG. 3A, at step 302, a set of calendar events is received. Of the events within the set of calendar events, each event includes at least one attribute but can include several attributes. Attributes include, but are not limited to, start time, stop time, duration, event date, event name, event location, attendees, location, and description. Many other attributes as known to those of ordinary skill in the art may be included for the events of the first set of calendar events. Also, the attributes may be fixed as in traditional calendaring applications. For example, an event can have fixed start and stop times for a fixed date. Moreover, the attributes can be flexible according to embodiments of the present invention. For example, flexible attributes can include flexible start and stop times, flexible dates, even flexible events. Further discussion will be provided regarding flexible events further below.

Note, however, that the set of events of step 302 can be, for example, previously entered events in an individual's calendar, and that the method of FIG. 3A is directed at entering new events. As such, the method of FIG. 3A could have been used to generate the set of events of step 302. The set of events of step 302 could have also been generated by other means also. For example, the set of events could have been imported from a calendar with pre-existing events. Also, the set of events of step 302 could have been generated by a combination of methods. Indeed, the set of events could have been generated by other means known to those of ordinary skill in the art

At step 304, an event to be calendared is received. Notable about the event to be calendared is that it includes at least one flexible event attribute. For example, whereas traditional calendaring systems have been limited to fixed start and stop times, an embodiment of the present invention allows for the input of flexible start and stop times. Other flexible event attributes include, but are not limited to, event tags, conditional events, multiple choice events, and long term events. These and other particular flexible event attributes will be discussed with regard to certain particular embodiments further below that will assist one of ordinary skill in the art to understand the breadth of the present invention.

At step 306, potential times are determined for the event to be calendared. Importantly, the times for the first calendar event are responsive to the attributes of the set of calendar events of step 302 and the at least one flexible event attribute of step 304. In a preferred situation, the determined potential times for the event to be calendared do not conflict with the set of calendar events. The present invention, however, contemplates that conflicts can arise such that certain of the potential times of step 306 for the event to be calendared of step 304 may conflict with certain of the set of events of step 302. In embodiments of the present invention conflicts between or among events and their impact is sought to be reduced. Further details regarding the manner of determining potential times for the event to be calendared will be provided with reference to certain embodiments described below.

At step 308, the event to be calendared is calendared by choosing at least one of the times determined at step 306. Where at least one time without conflicts is determined, the event to be calendared is calendared according to predetermined criteria. For example, where several times are possible without conflict, the earliest possible time is chosen. Such a criteria allows for the possibility of rescheduling this event in case a conflict arises later. Because the event of step 304 has flexible attributes, it may be possible to reschedule it according to its flexible attributes while avoiding future conflicts. Indeed, it is also possible to reschedule certain flexible events from the set of calendar events so as to find even more possibilities for the flexible event to be calendared.

In situations where the potential times determined at step 306 all have conflicts, at step 308, the event to be calendared is calendared with a conflict. In certain embodiments, however, an alert is presented to the user notifying him of the conflict. The user can then take action to resolve the conflict. It should be noted that certain embodiments of the present invention relate to concepts of hard and soft conflicts that have implications at steps 306 and 308 as described below with reference to certain embodiments.

Shown in FIG. 3B, is a method for calendaring an event whose flexible attribute includes flexible times, e.g., flexible start and stop times or flexible dates. Although the method of FIG. 3B is described in conjunction with the various system representations set forth herein, persons skilled in the art will understand that any system that describes the method steps, in any order, falls within the scope of the present invention.

The method of FIG. 3B is similar to the method of FIG. 3A but includes details for handling the flexible times. Shown in FIG. 3B is step 310 where flexible times are input and received as the flexible event attributes of step 304. For example, whereas traditional calendaring systems have been limited to fixed start and stop times, an embodiment of the present invention allows for the input of flexible start and stop times at step 310. With flexible start and stop times, a user can, for example, specify a one-hour event to occur within a larger block of time, say 1:00 PM and 5:00 PM of a given date. Alternatively, blocks of times can be specified over various dates.

The flexibility in times can then be considered at step 312 as shown in FIG. 3B to determine potential times at step 306 for the event to be calendared of step 304. For example, where an event from first set of calendar events is scheduled to occur from 1:00 PM to 3:00 PM of a day of interest, the event to be calendared with flexible start and stop times as described above, is determined to fit within 3:00 PM and 5:00 PM. Indeed, such a flexible one-hour event can begin anywhere between 3:00 PM and 4:00 PM so that it can end before the specified 5:00 PM. Such determinations, for example, are made at step 306.

At step 308, the event to be calendared is calendared according to the determined times of step 306. For example, in an embodiment of the present invention, the flexible event is scheduled as early as possible at 3:00 PM. In another embodiment of the present invention, a cushion of time is allotted between the end of an immediately prior event. For example, in an embodiment, the flexible event is allowed a 15 minute cushion from the immediately prior event and scheduled to begin at 3:15. Many criteria can be implemented for choosing among possible times. For example, an earliest possible time may be chosen so as to allow for the management of later occurring potential conflicts. Many other criteria are possible while keeping within the teachings of the present invention as would be known to those of ordinary skill in the art. Details of a preferred embodiment for managing flexible times will be provided further below.

Shown in FIG. 3C, is a method for calendaring an event whose flexible attribute includes an event tag that allows for flexibility in managing conflicts and calendaring events. Although the method of FIG. 3C is described in conjunction with the various system representations set forth herein, persons skilled in the art will understand that any system that describes the method steps, in any order, falls within the scope of the present invention.

The method of FIG. 3C is similar to the method of FIG. 3A but includes details for utilizing event tags. Shown in FIG. 3C is step 314 where event tags are input and received as the flexible event attributes of step 304. For example, the event tags can be associated with a prioritization of events, say rank A, B, and C, where rank A is the most important type of event and rank C is the least important type of event. In such a situation, a rank A event could be, for example, a meeting requested by a boss, a rank B event could be a meeting requested by a colleague, and a rank C event could be recreational event.

In determining appropriate times for scheduling a flexible event such as at step 306 of the method of FIG. 3C, the event tags can be considered at step 316. For example, in a situation where a rank A event overlaps with a rank C event, an embodiment of the present invention, gives priority to the rank A event over the rank C event at step 306. This situation can be considered a soft conflict because, whereas there is a conflict in times, there is a specified flexible attribute, the event tag, that provides criteria for automatically resolving the conflict without further user input. In a ranking situation where two events of the same rank are scheduled, an embodiment of the present invention considers both events with equal priority. This may be called a hard conflict because the event tag or other criteria may not resolve the conflict. Of course, times with no conflicts between or among events are also considered and are given priority over soft conflict and hard conflict situations at step 306.

With the determined potential times of step 306, the event to be calendared is calendared at step 308. For example, in an embodiment, where at least one no-conflict situation is determined, the earliest possible no-conflict time for the event is calendared. In another embodiment, a later time can be chosen. Where, there are no no-conflict situations, but there is at least one soft-conflict situation, the earliest possible soft-conflict time for the event is calendared. Where only hard-conflict situations are determined at step 306, the earliest possible hard-conflict time is scheduled. In an embodiment, a notification is provided to the user apprising him of the hard conflict situation while providing him an opportunity to resolve the conflict, e.g., providing a choice between or among conflicting events. Details of a preferred embodiment for managing event tags will be provided further below.

Shown in FIG. 3D, is a method for calendaring an event whose flexible attribute includes a condition for choosing between or among events based on predetermined conditions. Although the method of FIG. 3D is described in conjunction with the various system representations set forth herein, persons skilled in the art will understand that any system that describes the method steps, in any order, falls within the scope of the present invention.

The method of FIG. 3D is similar to the method of FIG. 3A but includes details for scheduling events based on predetermined conditions. Shown in FIG. 3C is step 318 where criteria for conditional events are input and received as the flexible event attributes of step 304. For example, conditional events can be logically structured in the form:

If condition A is true
then schedule event X
otherwise schedule event Y
In an embodiment of the present invention, the events X and Y are allowed to be null events (e.g., schedule nothing). In yet another embodiment, multiple conditions can be specified with several possible resulting scheduled events.

In a more concrete example, consider scheduling events based on weather. If a day is sunny, a user may desire to schedule a jog, but if it is not sunny, a user, may instead desire to schedule a gym workout. Thus, an embodiment of the present invention, receives such conditional information as a flexible attribute at step 318. The condition is then evaluated at step 320 for use in determining potential times for the event to be calendared at step 306. Receipt of the conditional information can be provided manually such as by the user or may be obtained automatically such as through the internet. For example, on the day of the flexible event of interest, the user may input a weather condition that then sets up a potential time for the conditional event at step 306. Still in another example, information can be automatically received such as through a web-based weather service that then sets up a potential time for the conditional event at step 306.

With the determined potential times of step 306, the event to be calendared is calendared at step 308. For example, where a weather condition was determined to be sunny, a jog is scheduled at step 308. Alternatively, where it was determined to be raining, a gym workout is scheduled. Details of a preferred embodiment for implementing conditional events will be provided further below.

Shown in FIG. 3E is a method for calendaring an event whose flexible attribute includes a choice between or among events. Although the method of FIG. 3E is described in conjunction with the various system representations set forth herein, persons skilled in the art will understand that any system that describes the method steps, in any order, falls within the scope of the present invention.

The method of FIG. 3E is similar to the method of FIG. 3A but includes details for scheduling events between or among events. Shown in FIG. 3E is step 322 where multiple choices for events are input and received as the flexible event attributes of step 304. For example, multiple choice events can generally be structured in the form of selecting one event from a list of multiple events. In a more concrete example, consider scheduling the attendance of one of several movies (e.g., movie A, B, or C) with various overlapping start and end times. An embodiment of the present invention, allows for the input of the times for the various overlapping movies for determination of which movie to attend to be evaluated at a later time.

A choice among the multiple choices can then be made subsequently at step 324. The choice can be made manually by a user, or can be made automatically according to a predetermined criteria. For example, on a periodic basis, the list of movies can be presented to the user for selection at step 324. Alternatively, as the start times are passed for certain of the choices, an evaluation is made not to attend such movie.

After a selection is made or evaluated at step 324 and potential times considered at step 306, an event is calendared as in step 308. In an embodiment of the present invention, machine learning algorithms can be applied to learn a user's behavior and predict a best choice for an event. Details of a preferred embodiment for implementing conditional events will be provided further below.

Whereas traditional calendaring systems may provide for identifying long-term tasks and To-Do lists, such traditional systems have not been able to schedule time for such tasks. In an embodiment, long-term tasks are addressed in two categories, those with no deadlines and those with deadlines.

Shown in FIG. 3F is a method for calendaring long-term tasks including To-Do events with no deadlines. In an embodiment, a long-term task is, for example, an event that is to be completed over an extended period of time. For example, certain long-term tasks cannot be completed in a single day. Although the method of FIG. 3F is described in conjunction with the various system representations set forth herein, persons skilled in the art will understand that any system that describes the method steps, in any order, falls within the scope of the present invention.

The method of FIG. 3F is similar to the method of FIG. 3A but includes details for scheduling events that address larger long-term tasks. Shown in FIG. 3F is step 326 where information including attributes for at least one long-term task is received and provided as input to step 304. In an embodiment, long-range tasks can be identified as desired to be calendared but no particular dates or times for such tasks need be identified. For example, where a user may desire to learn a foreign language over an extended period of time, he may not know when to schedule time for such a task over the course of his busy schedule. For such a long-range task, the dates, event duration, and start and stop times are, therefore, flexible and can be specified at step 326. An embodiment of the present invention keeps track of a user's various long-range tasks such as would be input at step 326 and determines potential times for such tasks at step 308. Toward determining potential times at step 306, input is received from a user at step 328 regarding interest in addressing the long-term task. For example, specific input can be received from a user regarding interest in scheduling time for the long range task. In an embodiment of the present invention, a user is presented with an interface where he can indicate interest in scheduling time for the long term task. For example, a user may select a button on an electronic calendar indicating his present availability, and the method of the present invention schedules time for the long-term task. In an embodiment, the event selected from the long-range tasks is scheduled immediately for a predetermined duration (e.g., one hour) or until a next event is schedule. Where there may be several long-term tasks previously identified, a random choice can be made among the various long-term tasks. In yet another embodiment, long-term tasks can be prioritized and calendaring can be made accordingly.

Shown in FIG. 3G is a method for calendaring long-term tasks including To-Do events with deadlines. Although the method of FIG. 3G is described in conjunction with the various system representations set forth herein, persons skilled in the art will understand that any system that describes the method steps, in any order, falls within the scope of the present invention.

The method of FIG. 3G is similar to the method of FIG. 3A but includes details for scheduling events that address larger long-term tasks with deadlines. Shown in FIG. 3G is step 330 where information including attributes for at least one long-term task is received and provided as input to step 304. In an embodiment, long-range tasks can be identified as desired to be calendared with specific dates and times for their completion. For example, where a user may desire to submit a scholarship application by a specified date and time, he may not know when to schedule time for such a task over the course of his busy schedule but knows that sufficient time must be scheduled. For such a long-range task, the dates, event duration, and start and stop times are, therefore, flexible and can be specified at step 330 along with a completion date. An embodiment of the present invention keeps track of a user's various long-range tasks such as would be input at step 330 and automatically evaluates a user's schedule at step 328 toward determining potential times at step 306. In another embodiment, user input can be received regarding interest in an identified long-term task (see step 328 of FIG. 3F). In an embodiment, the scheduling of long-term tasks is managed in a similar way as flexible time events in that they can be moved as conflicts may arise while staying within their specified parameters. Where there may be several long-term tasks previously identified with specified end dates, a random choice can made among the various long-term task. In yet another embodiment, long-term tasks can be prioritized and calendaring made accordingly.

In describing the methods of FIGS. 3A-3G it should be noted that they are not intended to be limiting. Indeed, certain of the details of the methods can be combined so as to provide further functionality.

To be described now are particular embodiments of the present invention. It should be understood, however, that the description of such particular embodiments is not intended to limit the scope of the present invention.

An embodiment of the present invention is implemented as a web-based tool that uses Google Calendar as a backend to store events. This implementation allows for making use of the database system already provided by Google. This implementation further provides ease of user adoption by allowing users to work with existing events, and provides ease in portability between or among different devices (e.g., computer, smart phone, and tablet). On the front-end side, an embodiment of the present invention has adapted the FullCalendar jQuery plugin to work with Google's Javascript API. Among other things, such an implementation provides a user-friendly experience.

It should be noted that the present invention can be implemented on many other calendaring systems including, Yahoo's, Apple's, or Microsoft's implementations. Moreover, the present invention can be implemented through APIs but can also be implemented as stand-alone software, among other implementations, as would be known to those of ordinary skill in the art.

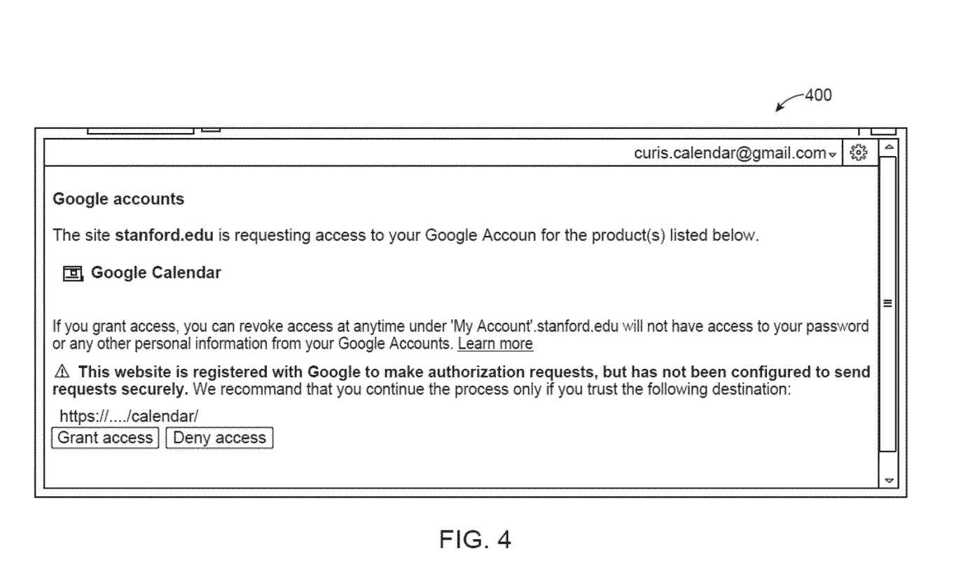

In an embodiment called Intelligent Calendar implemented using Google Calendar, a user is required to log in to Google and further required to provide permission for a user's Google calendar to be modified by an embodiment of the present invention such as through message 400 of FIG. 4. In this embodiment, a user is only required to provide this permission once, the first time he uses this embodiment.

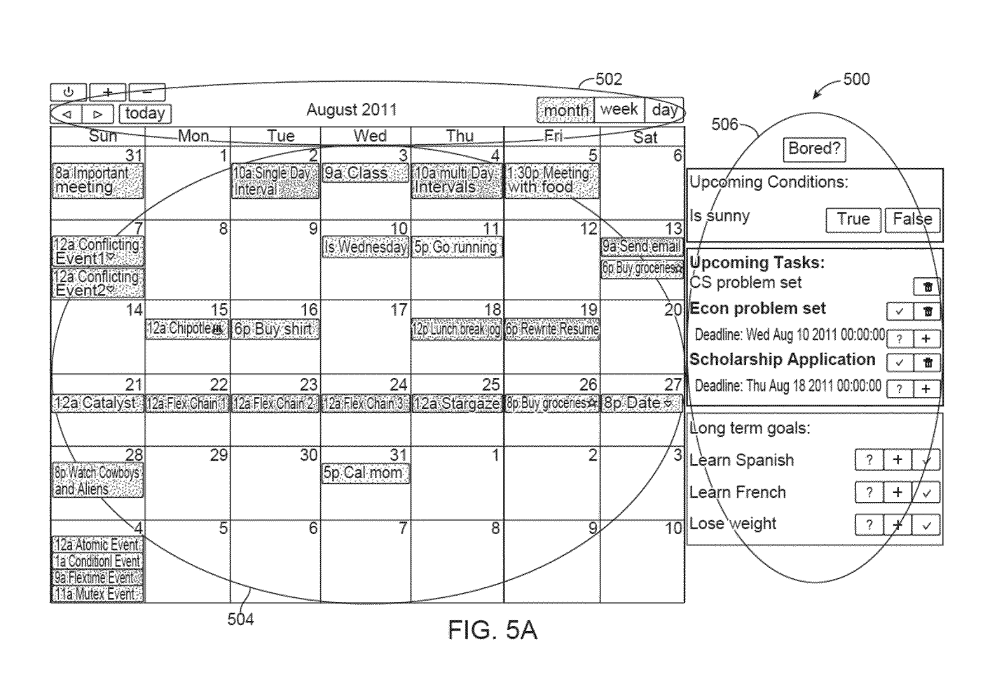

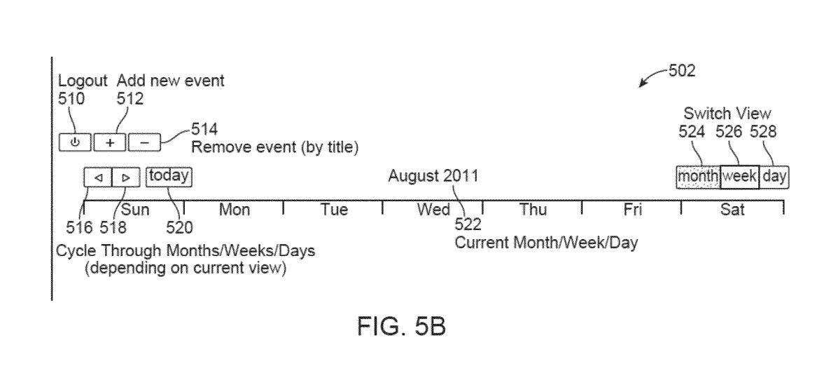

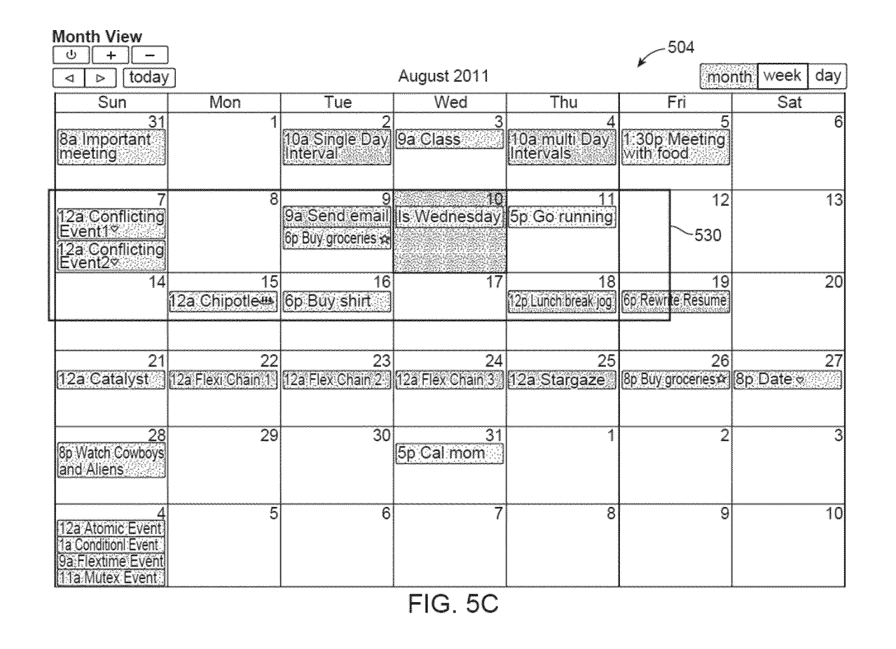

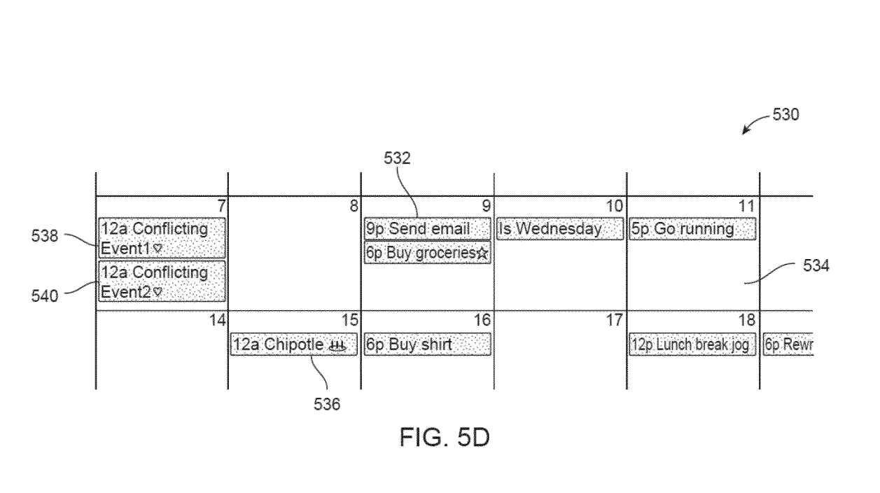

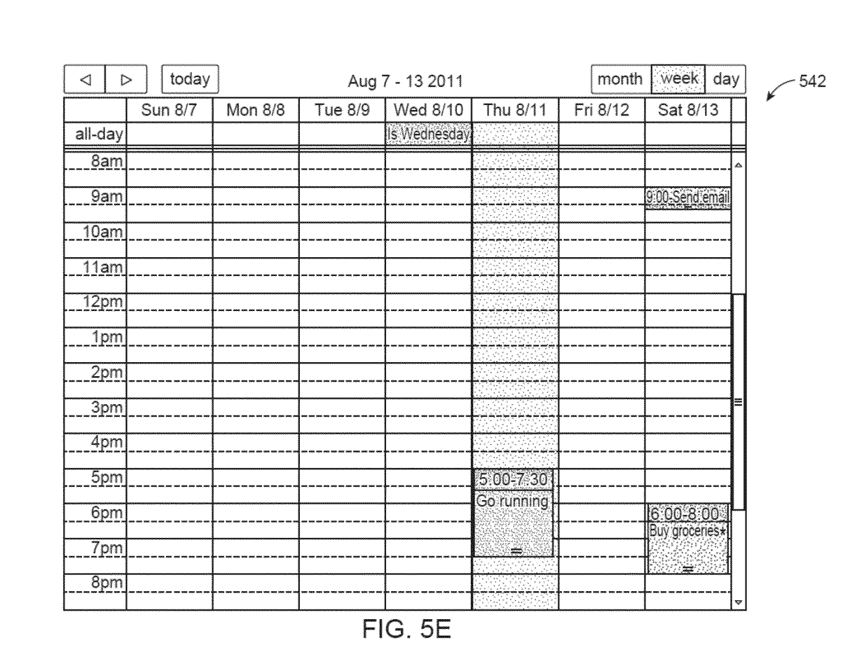

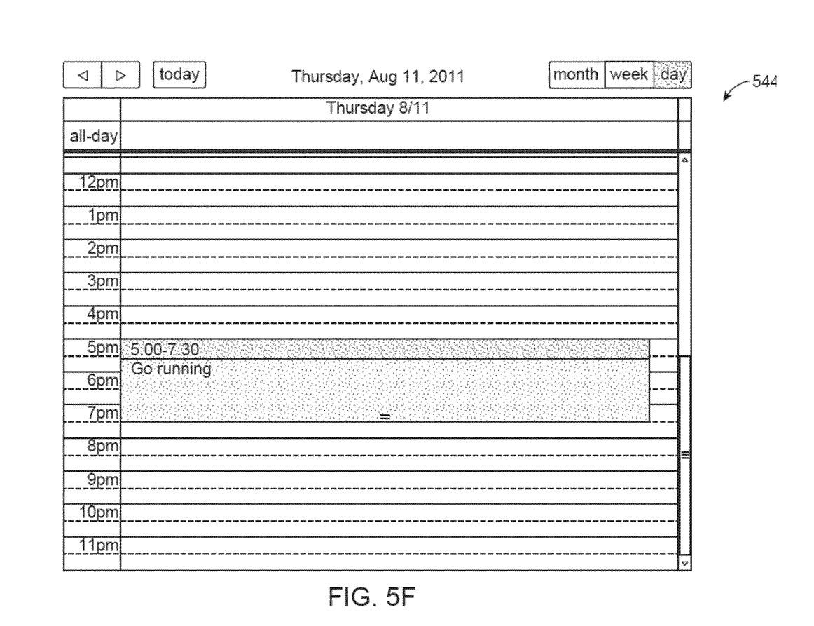

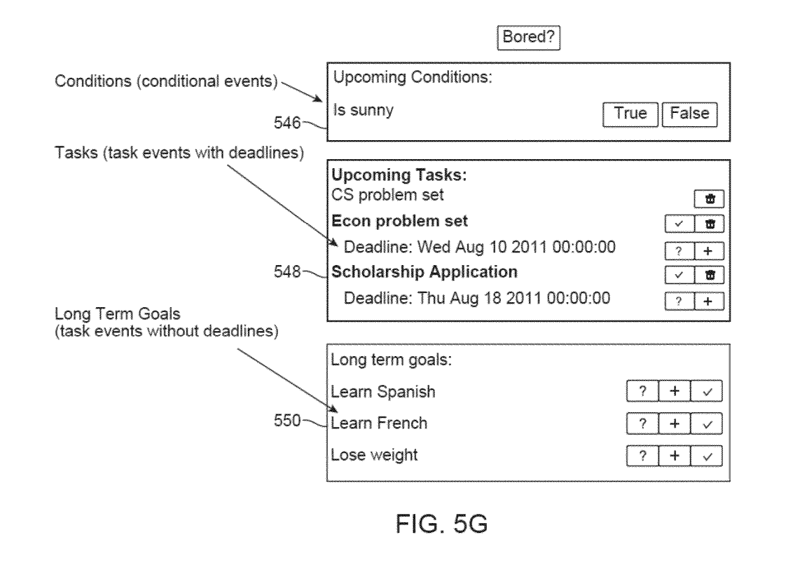

After providing permission, a user is presented with interface 500 as shown in FIG. 5A that generally includes sections 502, 504, and 506.

FIG. 5B shows section 502 in larger scale. As shown in FIG. 5B, section 502 includes logout button 510 for logging out of the present calendar session. Button 512 provides for adding new events including flexible events. Button 514 is provided for removing events. In one embodiment, events are identified and removed based on their title. Buttons 516 and 518 provide for cycling through various time views (e.g., prior month view or next month view, respectively). Heading 522 is provided to display a heading for the current view (e.g., current month, week, or day). Button 524 is provided for presenting a calendar in month view, button 526 in week view, and button 528 in day view.

FIG. 5C shows section 504 in larger scale. As shown in FIG. 5C, section 504 is used to display a user's various calendared events. For example, displayed on section 504 are some of the set of calendar events mentioned with reference to step 302 of FIG. 3A for the month of August 2011.

Shown in FIG. 5D is one week 530 of section 504. Various features of the present invention are shown in FIG. 5D. For example, an event start time 532 is shown for each event. The current day 534 is shown in grey. Also, event tag 536 is shown as an icon on an event. Conflicting events 538 and 540 are also displayed. Note that section 504 can also display a calendar in week view 542 as shown in FIG. 5E and day view 544 as shown in FIG. 5F. The week view shows the current week of events, but displays the time of day on the left hand side of the screen. In addition, each event has its start and end time displayed in its title, and its height is determined by its duration. Conflicting events overlap, making conflict detection and resolution easier for the user. The user can view all events for the day by using the day view.

FIG. 5G shows section 506 in larger scale. In an embodiment, section 506 is called the Side Bar. Side bar 506 allows the user to interact with some of the special kinds of events supported by the Intelligent Calendar as an embodiment of the present invention. For example, box 546 provides an interface for interacting with conditional events of the present invention. As shown, a condition presented is the question “Is it sunny?” relating to a conditional event. The user is thereby provided an interface for inputting the condition (e.g., yes or no buttons). Box 548 provides a list of tasks and box 550 provides a list of long-term goals according to embodiments of the present invention. Further details of Side bar 506 will be provided below.

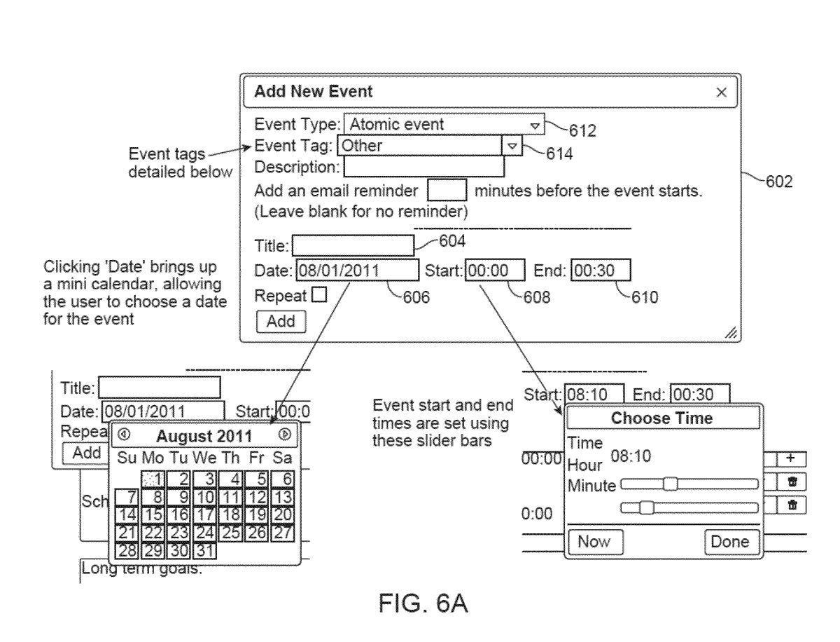

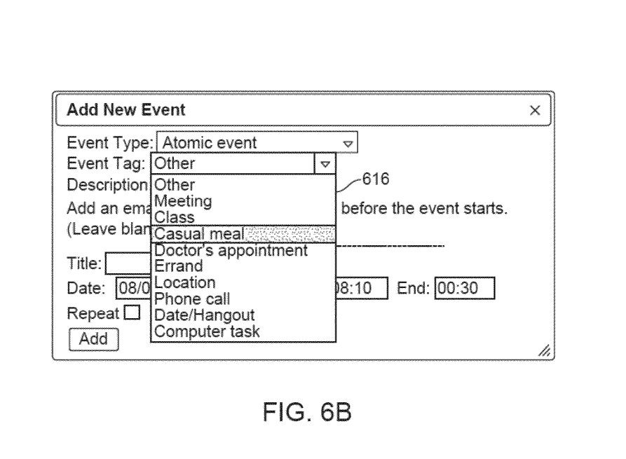

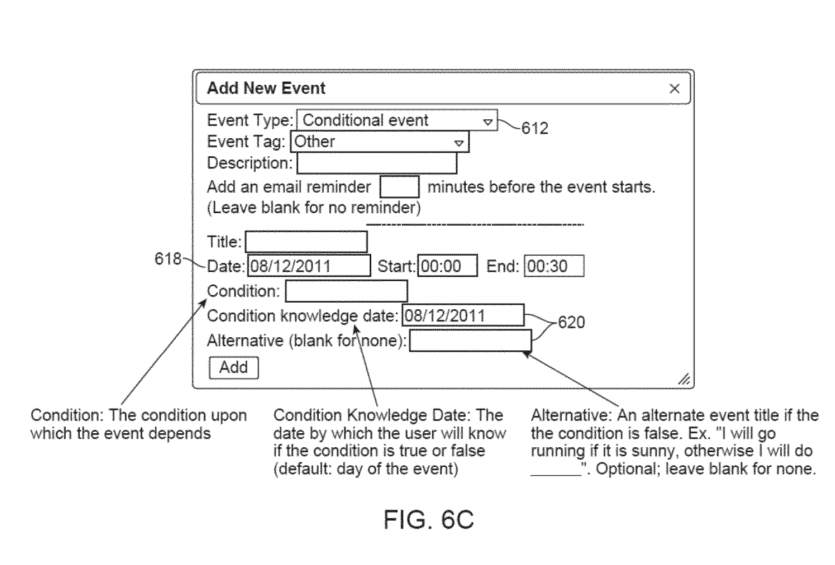

In order to add a new event, a user can click on button 512 as shown in FIG. 5B. A user is then presented with dialog box 602 as shown in FIG. 6A through which a user can enter a title 604 for the event as well as date 606, start time 608, and stop time 610. According to an embodiment of the present invention, a user can also enter event type 612 and event tag 614. When selecting an “atomic event” as shown, the event tags can have symbols associated with them so as to provide a visual indication as to their meaning (see 536 of FIG. 5D). In an embodiment, the event tags also provide for conflict detection and resolution. See FIG. 6B for a list 616 of event tags. When scheduling events that overlap, the calendar responds differently depending on the types of events. As an example, consider the situation where event A is already in the calendar (see steps 304 and 314 of FIG. 3C) and the user attempts to schedule flexible event B at the same time (see steps 306 and 316 of FIG. 3C). If event A is of type “meeting” and B is of type “casual meal,” this can be considered a “soft conflict” such that it may be possible to schedule both events at the same time. For example, it may be possible to eat takeout food and have a meeting at the same time. In an embodiment, a user receives notice of a soft conflict but both events are calendared. But if event A is of type “meeting” and event B is of type “Doctor's Appointment,” the overlap is designated as a “hard conflict,” since both events cannot be attended at the same time. In any case, the new event is not scheduled and the user is presented with a warning message where the user may reschedule the new event, schedule the new event despite the conflict, or cancel the process.

When a “Conditional event” is selected for event type 612 as shown in FIG. 6C, further options are provided including condition box 618 that describes the condition upon which the event depends (see steps 304 and 318 of FIG. 3D). Also provided is box 620 where a date can be input by which a user will know if a condition is true or false. Box 622 is provided as an alternative title if the condition is false (e.g., “I will go running if it is sunny, otherwise I will do [Alternative]”). In an embodiment, the alternative can be left blank.

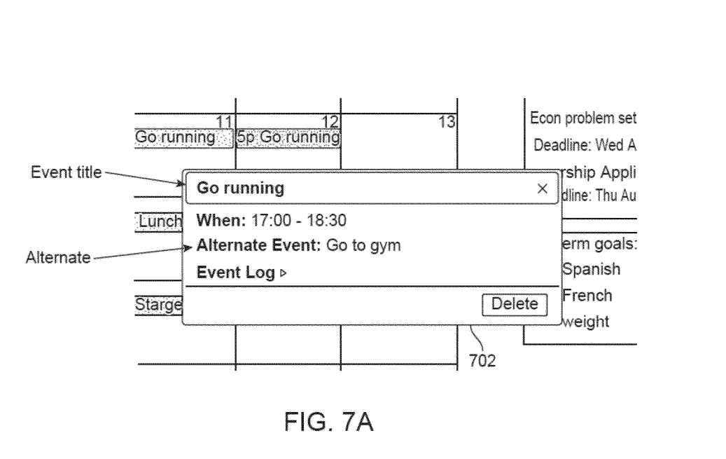

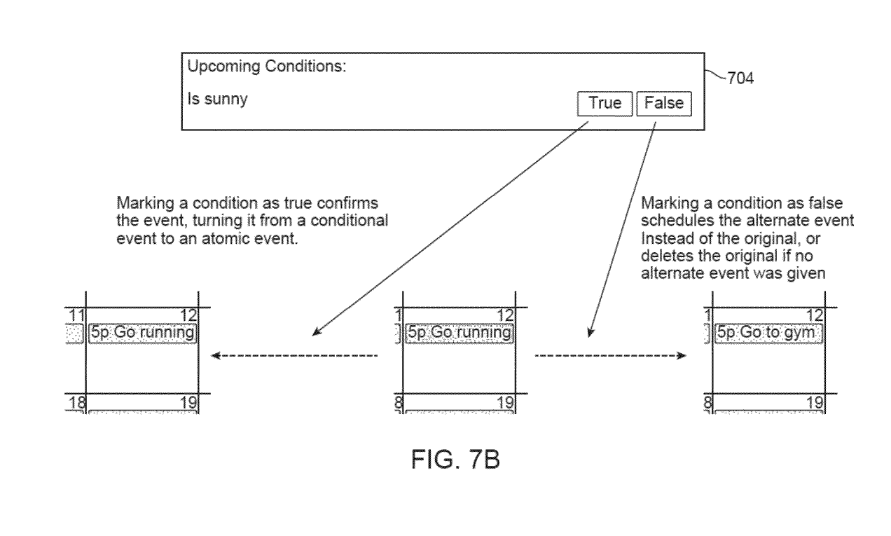

An interaction for a conditional event will now be described for the flexible event, “I will go running if it is sunny, otherwise I will go to the gym.” A summary dialog box 702 is provided in FIG. 7A for such a conditional event. On the day corresponding to the conditional knowledge date, a dialog box 704 appears as shown in FIG. 7B where a user can input whether it is sunny or not. Based on the response, one or the other conditional event is scheduled. In an alternative embodiment, the response could be obtained automatically through a web-based weather service.

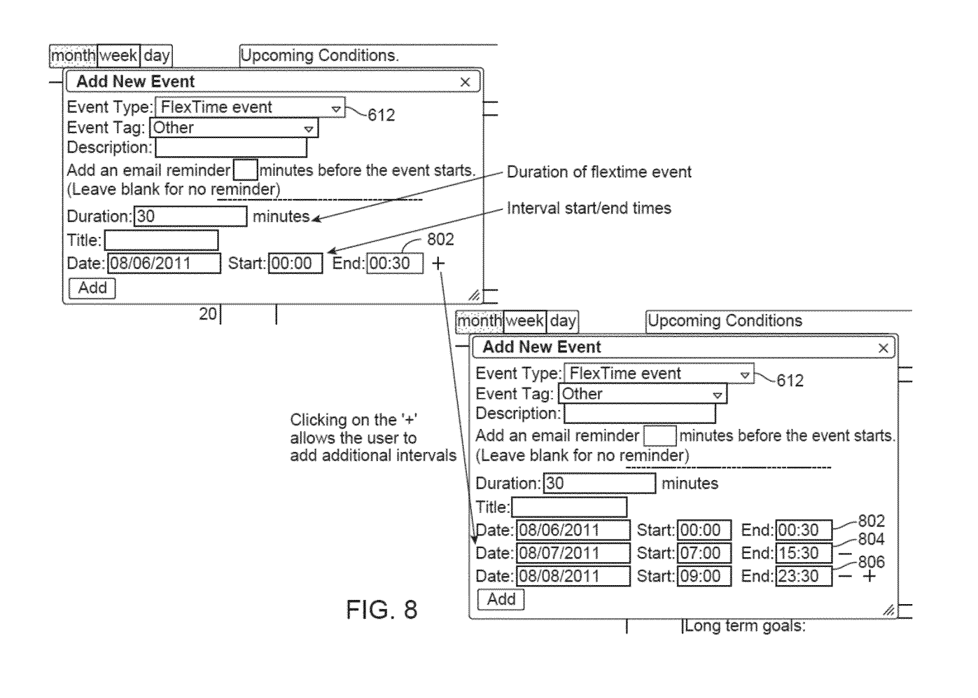

When a “FlexTime event” is selected for event type 612 selected as shown in FIG. 8, further options are provided for specifying ranges of times when an event can be scheduled. For example, as shown in FIG. 8, a user can specify interval 802 and can click on plus symbol 810 so as to add further intervals such as 804 and 806 where each interval can be up to a full day long (see steps 304 and 310 of FIG. 3B). Among other things that can be specified for a FlexTime event is a duration for the event. In this way, an embodiment of the present invention has flexibility in determining an appropriate time for this event (see steps 306 and 312 of FIG. 3B).

When a new flexible time event is created, it is scheduled at the earliest available time within its earliest available interval, for example. For the example of FIG. 8, if a user has an event from 5:00 pm to 6:30 pm (e.g., step 302 of FIG. 3B) and creates a flexible time with an interval from 5:00 pm to 8:00 pm the same day (e.g., steps 304 and 310 of FIG. 3B), the flexible time would initially be scheduled at 6:30 pm (e.g., step 308 of FIG. 3B). If the user then schedules another event at 6:30 that conflicts with the FlexTime event, then the conflict is detected and the FlexTime event is rescheduled to, for example, 7:00 PM, to resolve the conflict. And if another conflict was added that took up the remainder of the first interval 802, the FlexTime event is moved to its next interval. In the example, the next interval 804 occurs on the next calendar day. When a FlexTime event needs to be rescheduled but has no open spots in any of its intervals, a next option can be to move other flextime events and schedule itself in newly opened time slots (see steps 306, 312, and 308 of FIG. 3B). In an embodiment, a user can tentatively schedule a FlexTime event during any open slot within the specified time intervals, but as necessary such tentative scheduling can be moved.

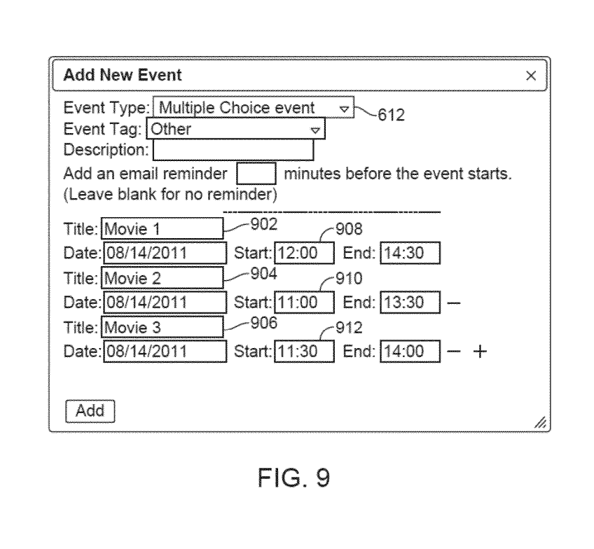

When a “Multiple Choice Event” is selected for event type 612 selected as shown in FIG. 9, further options are provided for specifying choices between or among various alternative events. For example, as shown in FIG. 9, a user can specify alternative events 902, 904, and 906 as occurring during overlapping times 908, 910, and 912, respectively (see steps 304 and 322 of FIG. 3E). Whereas a user could schedule a FlexTime event when he is not dedicated to a specific time, a user could alternatively schedule a multiple choice event when his is not dedicated to a specific event.

For example, suppose a user wants to go to a movie during a particular week, but cannot decide among three different movies, each with different show times. The user can enter the three movies as a multiple choice event and can leave the decision up to the calendar (see steps 306, 324, and 308 of FIG. 3E). The process for adding a multiple choice event as shown in FIG. 9 is similar to that of adding a flextime event.

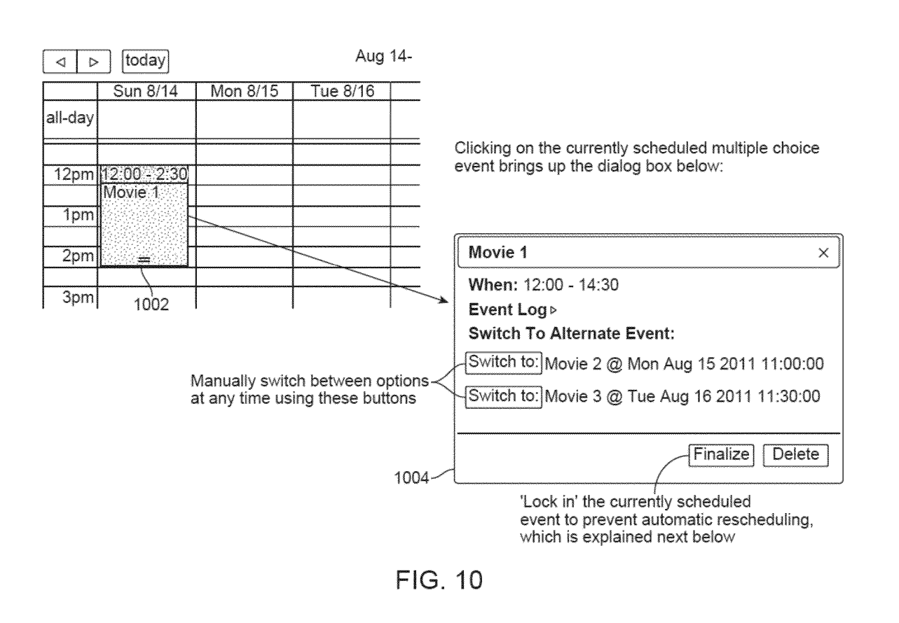

In an embodiment, upon creating a multiple choice event, the earliest available option provided by the user is scheduled (see steps 306, 324, and 308 of FIG. 3E), for example, Movie 1 according to the parameters of FIG. 9. At a time before the event, a user can click on the calendared event 1002 as shown in FIG. 10 so as to bring up dialog box 1004. Using dialog box 1004, a user can manually switch between or among alternative events using button 1006 to select Movie 2 or button 1008 to select Movie 3 and subsequently selecting Finalize button 1008. An embodiment of the present invention provides for rescheduling of multiple choice events (see steps 306, 324, and 308 of FIG. 3E) as a user's calendar may create conflicts with one or more of the alternative multiple choice events. In an embodiment, however, options are provided to a user to lock in multiple choice events so as to prevent rescheduling.

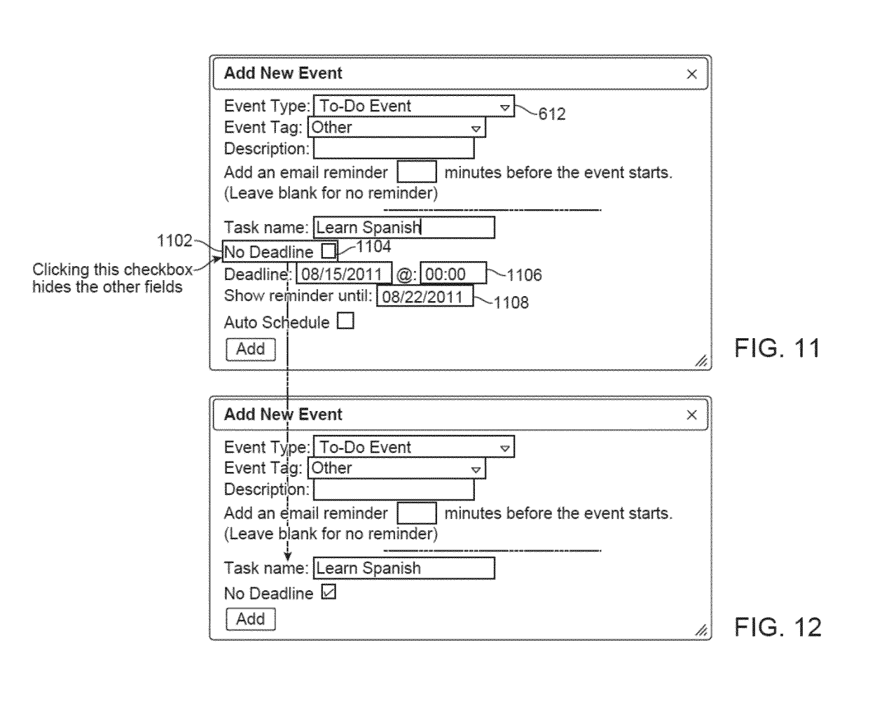

When a “To-Do Event” is selected for event type 612 as shown in FIG. 11, further options are provided for specifying events of unknown duration. For example, as shown in FIG. 11, a user can specify whether a To-Do event has a deadline or not using checkbox 1102. Where a deadline exists as shown in FIG. 11, a user can provide a date 1104 and time 1106 for the deadline. In an embodiment, a user can be provided periodic reminders about the To-Do Event until a specified date 1108.

A To-Do Event with a deadline can be, for example, homework problem sets, reports, and essays. A To-Do Event without a deadline can be, for example, long term goals. A long term goal can be something like “lose weight” or “learn a new language,” essentially tasks that have an unknown duration with no particular completion date specified.

In traditional calendaring systems, To-Do Events may be listed but there is not manner for integrating them into a user's schedule. In an embodiment of the present invention, however, reminders are periodically provided of their existence and any potential deadlines. Also, an embodiment of the present invention provides for scheduling time for To-Do Events into a user's schedule. In this way, long-term task events are broken down and scheduled into reasonable and concrete increments of scheduled time. Moreover, scheduling of task events according to an embodiment of the present invention allows a user to turn an abstract idea like “lose weight” into a tangible and scheduled events (e.g., scheduled times to run or go to the gym).

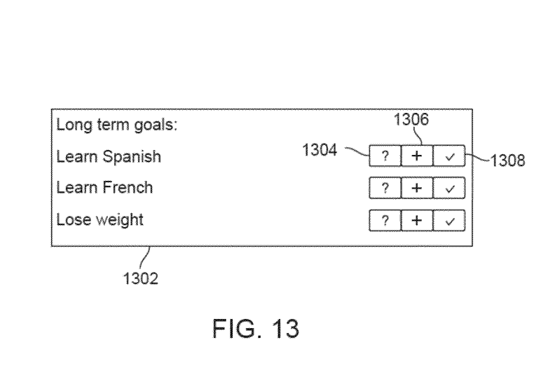

Shown in FIG. 12 is an entry for a To-Do Event (“Learn Spanish”) with no deadline. In an embodiment, when a To-Do event with no deadline has been added, it shows up in “Long Term Goals” box 1302 of FIG. 13. Using the buttons of Long Term Goals box 1302, a user can schedule time for the goal or mark it as completed. For example, by selecting button 1304, time is randomly selected during available time in a user's current day for the user to work on the long range goal (e.g., learn Spanish). But if no time is available during the current day, no time is scheduled for working on the long range task. Button 1306 is provided for finding the earliest available free time during a user's current day for the user to work on the long range goal (e.g., learn Spanish). In another embodiment, button 1306 schedules an earliest possible time to work on the long rang task even if it is not the current day. Button 1308 is provided for a user to indicate when he feels he has completed the long-term task. Clicking on button 1308 removes the item from Long Term Goals box 1302.

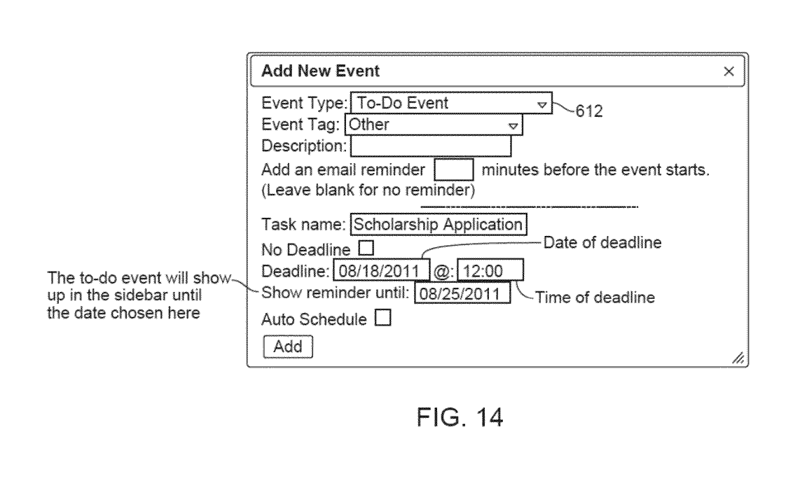

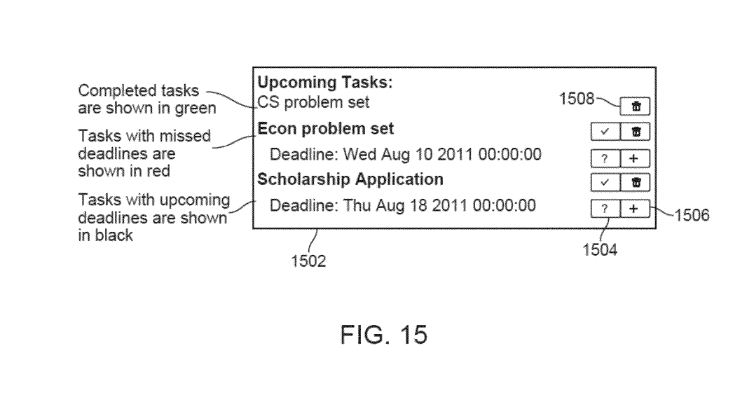

Shown in FIG. 14 is an entry for a To-Do Event (“Scholarship Application”) with a deadline (Aug. 18, 2011 at 12:00 PM). In an embodiment, when a To-Do event with a deadline has been added, it shows up in Upcoming Tasks box 1502 of FIG. 15. In an embodiment, completed tasks are shown in a first color (e.g., green), missed deadlines are shown in a second color (e.g., red), and upcoming deadlines are shown in a third color (e.g., black). Using the buttons of Upcoming Tasks box 1502, a user can schedule time for the goal or mark it as completed. For example, by selecting button 1504, time is randomly selected during available time in a user's current day for the user to work on the long-term task (e.g., fill out scholarship application). But if no time is available during the current day, no time is scheduled for working on the long-term task. Button 1506 is provided for finding the earliest available free time during a user's current day for the user to work on the long range goal (e.g., learn Spanish). In another embodiment, button 1506 schedules an earliest possible time to work on the long rang task even if it is not the current day. Button 1508 is provided for a user to indicate when he feels he has completed the long-term task. Clicking on button 1508 removes the specified item from the list of upcoming events.

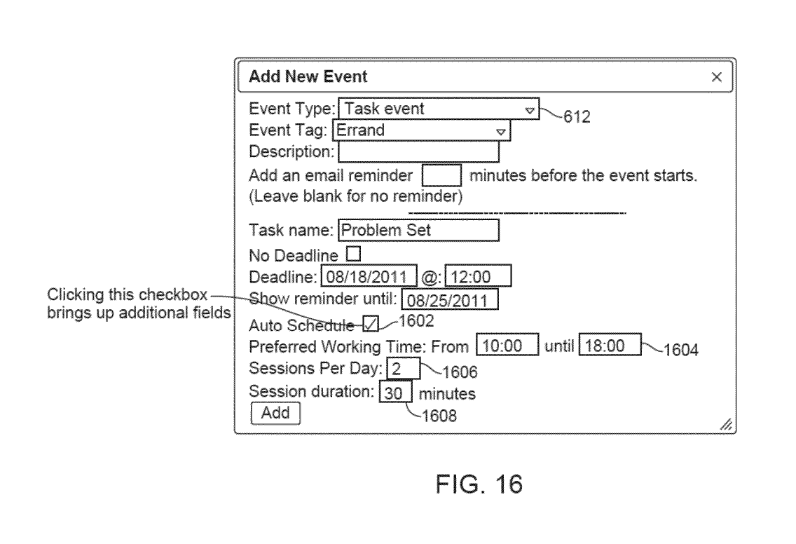

In an embodiment, time to work on To-Do event with a deadline can automatically be scheduled by selecting checkbox 1602 as shown in FIG. 16. Upon selection of checkbox 1602, further options are provided including preferred times 1604 for working on the task, the number of sessions 1606 to schedule during a given day, and the duration 1608 for each session. Upon adding this type of task, it will show up in the Upcoming Tasks box, but time to work on such task will be automatically calendared until it is completed. Time to work on such a task will be limited to the sessions entered and the preferred times. In an embodiment, times are randomly selected from the free time in the user's calendar. In another embodiment, the earliest possible times are calendared. In yet another embodiment, scheduling of To-Do events is done similarly as for FlexTime events in that they can be rescheduled when conflicts arise.

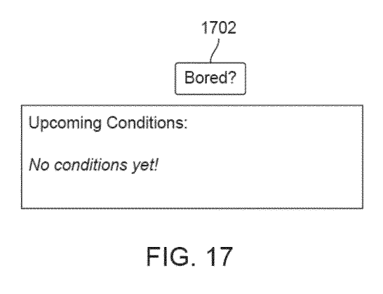

For the various To-Do Events, a further button 1702 as shown in FIG. 17 is provided for a user to indicate that he has time to work on a long-term goal. Upon clicking on button 1702, one of the user's long term goals is identified, and time is calendared immediately for working on such task. Presumably, a user would select button 1702 when he has nothing else scheduled and may be bored. But if the user has a pending event, or is currently in the middle of an event, an embodiment of the present invention notifies the user of the conflict and seeks confirmation that time for a long-term task should be scheduled.

Various embodiments of the present invention have been described. It should be noted that the present invention is not limited to the described embodiments. Indeed, several of the described embodiments could be combined to provide further combined functionality. Also, it should be noted that the present invention can be modified in ways known to those of ordinary skill in the art without deviating from the present invention. For example, the present invention can be implemented in stand-alone calendaring systems intended for individual users but can also be implemented in a networked environment where users can share information so as to provide others with the ability to schedule or propose events during appropriate times. Indeed methods described above can be implemented in multi-user environments where the flexible events of other users are considered.

One embodiment of the present invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

As persons skilled in the art will appreciate, the implementations and examples described herein in no way limit the scope of the present invention. While the foregoing is directed to embodiments of the present invention, other and further embodiments of the invention may be devised without departing from the basic scope thereof, and the scope thereof is determined by the claims that follow.

What is claimed is:

1. A computer-implemented method for calendaring events comprising:
receiving a first set of calendar events wherein each event within the first set of calendar events includes at least one attribute;
receiving a first flexible event wherein the first flexible event includes at least one flexible attribute;
calendaring the first flexible event responsive to the attributes for the first set of calendar events and the at least one flexible attribute of the first calendar event.

2. The method of claim 1, further comprising determining at least one potential time for the first flexible event and calendaring the first flexible event during one of the at least one potential time.

3. The method of claim 1, wherein at least one calendar event from the first set of calendar events includes at least one fixed attribute.

4. The method of claim 1, wherein at least one calendar event from the first set of calendar events includes at least one flexible attribute.

5. The method of claim 1, wherein the at least one calendar event from the first set of calendar events is rescheduled.

6. The method of claim 1, wherein the at least one flexible attribute for the first flexible event is at least one flexible time.

7. The method of claim 6, wherein the flexible time is a start time.

8. The method of claim 6, wherein the flexible time is a stop time.

9. The method of claim 6, wherein the flexible time is a date.

10. The method of claim 6, further comprising determining at least one potential time for the first flexible event within the at least one flexible time and calendaring the first flexible event during one of the at least one potential time.

11. The method of claim 1, wherein the at least one flexible attribute for the first flexible event is an event tag.

12. The method of claim 11, wherein the event tag indicates a priority for the first flexible event.

13. The method of claim 12, further comprising determining at least one potential time for the first flexible event wherein one of the at least one potential time is in conflict with a second flexible event, wherein an event tag for the first flexible event supersedes an event tag for the second flexible event, and calendaring the first flexible event during one of the at least one potential time.

14. The method of claim 12, further comprising determining at least one potential time for the first flexible event wherein one of the at least one potential time is in conflict with a second flexible event, wherein an event tag for the first flexible event is compatible with an event tag for the second flexible event, and calendaring the first flexible event during one of the at least one potential time.

15. The method of claim 11, wherein the event tag indicates a manner by which to resolve conflicts between or among events.

16. The method of claim 1, wherein the at least one flexible attribute for the first flexible event is conditional event.

17. The method of claim 16, wherein the conditional event is a choice between events that depends on a condition.

18. The method of claim 16, wherein an evaluation of the conditional event is received from a user.

19. The method of claim 16, wherein an evaluation of the conditional event is determined automatically.

20. The method of claim 1, wherein the at least one flexible attribute for the first flexible event is multiple choice event.

21. The method of claim 20, wherein the multiple choice event is a choice between or among multiple choices.

22. The method of claim 20, wherein a choice for the multiple choice event is received from a user.

23. The method of claim 20, wherein a choice for the multiple choice event is made automatically.

24. The method of claim 1, wherein the at least one flexible attribute for the first flexible event is a long-term event.

25. The method of claim 24, wherein the long-term event does not have a specified end time.

26. The method of claim 24, wherein the long-term event includes a specified end time.

27. The method of claim 24, further comprising receiving an indication to schedule time for the first flexible event.

28. The method of claim 24, further comprising automatically scheduling time for the first flexible event.

29. The method of claim 24, further comprising determining at least one potential time for the first flexible event within a user's available time and calendaring the first flexible event during one of the at least one potential time.

30. A computer-readable medium including instructions that, when executed by a processing unit, cause the processing unit to implement a method for calendaring events, by performing the steps of:
receiving a first set of calendar events wherein each event within the first set of calendar events includes at least one attribute;
receiving a first flexible event wherein the first flexible event includes at least one flexible attribute;
calendaring the first flexible event responsive to the attributes for the first set of calendar events and the at least one flexible attribute of the first calendar event.

31. The computer-readable medium of claim 30, further comprising determining at least one potential time for the first flexible event and calendaring the first flexible event during one of the at least one potential time.

32. The computer-readable medium of claim 30, wherein at least one calendar event from the first set of calendar events includes at least one fixed attribute.

33. The computer-readable medium of claim 60, wherein at least one calendar event from the first set of calendar events includes at least one flexible attribute.

34. The computer-readable medium of claim 30, wherein the at least one calendar event from the first set of calendar events is rescheduled.

35. The computer-readable medium of claim 30, wherein the at least one flexible attribute for the first flexible event is at least one flexible time.

36. The computer-readable medium of claim 35, wherein the flexible time is a start time.

37. The computer-readable medium of claim 35, wherein the flexible time is a stop time.

38. The computer-readable medium of claim 35, wherein the flexible time is a date.

39. The computer-readable medium of claim 35, further comprising determining at least one potential time for the first flexible event within the at least one flexible time and calendaring the first flexible event during one of the at least one potential time.

40. The computer-readable medium of claim 30, wherein the at least one flexible attribute for the first flexible event is an event tag.

41. The computer-readable medium of claim 40, wherein the event tag indicates a priority for the first flexible event.

41. The computer-readable medium of claim 41, further comprising determining at least one potential time for the first flexible event wherein one of the at least one potential time is in conflict with a second flexible event, wherein an event tag for the first flexible event supersedes an event tag for the second flexible event, and calendaring the first flexible event during one of the at least one potential time.

43. The computer-readable medium of claim 41, further comprising determining at least one potential time for the first flexible event wherein one of the at least one potential time is in conflict with a second flexible event, wherein an event tag for the first flexible event is compatible with an event tag for the second flexible event, and calendaring the first flexible event during one of the at least one potential time.

44. The computer-readable medium of claim 40, wherein the event tag indicates a manner by which to resolve conflicts between or among events.

45. The computer-readable medium of claim 30, wherein the at least one flexible attribute for the first flexible event is conditional event.

46. The computer-readable medium of claim 45, wherein the conditional event is a choice between events that depends on a condition.

47. The computer-readable medium of claim 45, wherein an evaluation of the conditional event is received from a user.

48. The computer-readable medium of claim 45, wherein an evaluation of the conditional event is determined automatically.

49. The computer-readable medium of claim 30, wherein the at least one flexible attribute for the first flexible event is multiple choice event.

50. The computer-readable medium of claim 49, wherein the multiple choice event is a choice between or among multiple choices.

51. The computer-readable medium of claim 49, wherein a choice for the multiple choice event is received from a user.

52. The computer-readable medium of claim 49, wherein a choice for the multiple choice event is made automatically.

53. The computer-readable medium of claim 30, wherein the at least one flexible attribute for the first flexible event is a long-term event.

54. The computer-readable medium of claim 53, wherein the long-term event does not have a specified end time.

55. The computer-readable medium of claim 53, wherein the long-term event includes a specified end time.

56. The computer-readable medium of claim 53, further comprising receiving an indication to schedule time for the first flexible event.

57. The computer-readable medium of claim 53, further comprising automatically scheduling time for the first flexible event.

58. The computer-readable medium of claim 53, further comprising determining at least one potential time for the first flexible event within a user's available time and calendaring the first flexible event during one of the at least one potential time.

59. A computing device comprising:
a data bus;
a memory unit coupled to the data bus;
at least one processing unit coupled to the data bus and configured to
receive a first set of calendar events wherein each event within the first set of calendar events includes at least one attribute;
receive a first flexible event wherein the first flexible event includes at least one flexible attribute;
calendar the first flexible event responsive to the attributes for the first set of calendar events and the at least one flexible attribute of the first calendar event.
